(19) United States
(12) Patent Application Publication
(10) Pub. No.: US 2019/0162145 A1
(43) Pub. Date: May 30, 2019

(54) FUEL INJECTOR ASSEMBLY

(71) Applicant: GM GLOBAL TECHNOLOGY OPERATIONS LLC, Detroit, MI (US)

(72) Inventors: Abhishek Kumar Sahu, Bengaluru (IN); Asok K Sethy, Bengalore (IN)

(21) Appl. No.: 15/824,936

(22) Filed: Nov. 28, 2017

(51) Int. Cl. F02M 61/14; F02F 1/24

(52) U.S. Cl. CPC F02M 61/14; F02F 1/242

(57) ABSTRACT

A fuel injector assembly for a vehicle includes an engine head, a fuel injector, and a preloading insert. The engine head defines a bore wherein the bore includes a head region proximate to the corresponding combustion chamber. The pre-loading insert may be disposed within the bore at the head region. The pre-loading insert may be configured to apply a tensile hoop stress to the head region of the bore causing plastic deformation to the head region while also supporting the fuel injector within the bore. The fuel injector may be configured to dispense fuel into a combustion chamber.

### TECHNICAL FIELD

The present disclosure generally relates to vehicle engines, and in particular, a fuel injector assembly for a vehicle.

### BACKGROUND

The present invention relates generally fuel injector assemblies which may be subject to thermo-mechanical fatigue as the fuel injector assembly is subjected to temperatures which may cycle between temperatures in excess of 300 degrees Celsius due to combustion reactions in an engine all the way to freezing ambient temperatures when a vehicle engine has cooled.

A fuel injector assembly may include an engine head which defines a bore wherein the bore is configured to house the fuel injector having an outer diameter which is less than the inner diameter of the bore. As a result, the traditional bore (and its material such as aluminum) undergoes repeated compressive loads due to thermal material expansion as the engine temperatures increase above 300 degrees Celsius. The traditional bore also repeatedly cycles back to tensile loads as the traditional bore (and its material) undergoes a cooling process and contracts when the vehicle engine is not in operation. The repeated cycling across the extreme temperature range may cause the material/bore structure to fatigue due to the repeated expansion and contraction of the material thereby causing cracking and/or other damage to the bore structure—particularly at the region of the bore which is proximate to the combustion chamber.

The above information disclosed in this Background section is only for enhancement of understanding of the background of the invention, and therefore, it may contain information that does not form the prior art that is already known in this country to a person of ordinary skill in the art. Accordingly, there is a need for a fuel injector assembly with improved thermal management performance.

### SUMMARY

The present disclosure provides a fuel injector assembly for a vehicle which includes an engine head, a fuel injector, and a preloading insert. The engine head defines an engine head bore or bore wherein the bore includes a head region. The pre-loading insert may be disposed within the head region of bore. The pre-loading insert may be configured to apply a tensile hoop stress to the head region of the bore causing plastic deformation to the head region while also supporting the fuel injector within the bore. The fuel injector may be configured to dispense fuel into a combustion chamber. It is understood that the engine head may define more than one bore wherein a pre-loading insert and a fuel injector may be disposed in each bore.

The pre-loading insert may be formed from stainless steel and includes an outer diameter at the head region which is greater than the inner diameter of the bore by about 30 to 50 microns. It is understood that the head region for the bore is the region proximate to a corresponding combustion chamber of the engine, and that the pre-loading insert substantially spans the head region of the bore. Furthermore, the preloading insert disposed within the head region of the bore is disposed between the corresponding fuel injector and combustion chamber.

The pre-loading insert may be configured to apply a tensile hoop stress to the head region of the bore given that the pre-loading insert includes an outer diameter which is greater than an inner diameter of the head region. Given that the pre-loading insert is disposed between the fuel injector and the combustion chamber, the pre-loading insert may, but not necessarily, also providing vertical support to the fuel injector within the bore. Nonetheless, upon insertion of the preloading insert into the bore, the head region of the bore is configured to elastically deform.

Accordingly, upon engine operation and high temperatures, the pre-loaded tensile hoop stress in the head region of the bore is at least partially offset by the compression loads experienced by the head region the temperature rises in excess of 300 degrees Celsius—resulting in reduced thermo-mechanical fatigue of the bore. As a result, the head region of the bore which is subjected to a much higher temperature gradient than the rest of the bore, experiences a reduced compressive stress upon engine heat-up due to the pre-loaded tensile hoop stress from the pre-loading insert.

The head region of the bore may be subject to a tensile hoop stress given that the outer diameter of the pre-loading insert (disposed within the head region of the bore) is slightly greater than the inner diameter of the head region in the more. In one non-limiting example, the outer diameter of the pre-loading insert may be greater than the inner diameter of the head region of the bore by approximately 30 to 50 microns. The pre-loading insert may further include a first end having a first outer diameter as well as a second end having a second outer diameter. The first end of the pre-loading insert is disposed within the head region and is generally disposed proximate to the combustion chamber. The second end of the pre-loading insert may also be configured to substantially provide vertical support to the injector within the engine head. The pre-loading insert may, but not necessarily, be formed from a steel alloy. Moreover, the engine head may be formed from aluminum.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 illustrates a schematic cross-sectional view of a fuel injector assembly according to various embodiments of the present disclosure.

FIG. 2A illustrates a partial view of a vehicle engine according to various embodiments of the present disclosure

FIG. 2B illustrates an example, non-limiting fuel injector of the present disclosure.

FIG. 3 illustrates a plan view of an example, non-limiting engine head of the present disclosure.

FIG. 4 illustrates a cross-sectional view of an example, non-limiting bore of the present disclosure.

FIG. 5A illustrates an isometric view of an example, non-limiting pre-loading insert of the present disclosure.

FIG. 5B illustrates a cross-sectional view of the pre-loading insert of the present disclosure.

FIG. 5C illustrates an isometric view of a second example, non-limiting pre-loading insert of the present disclosure.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any manner.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

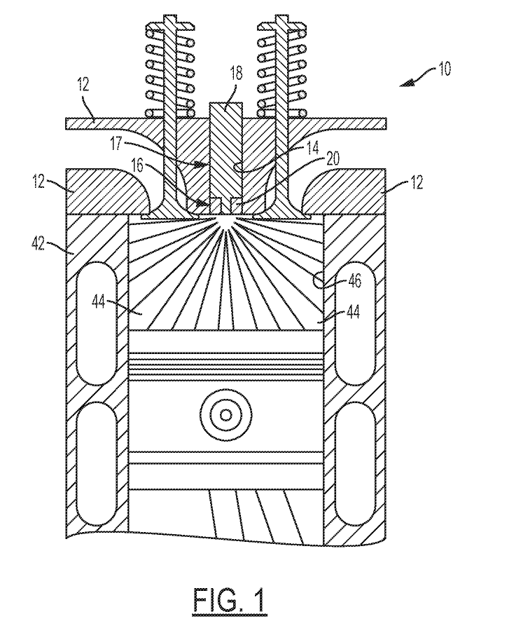

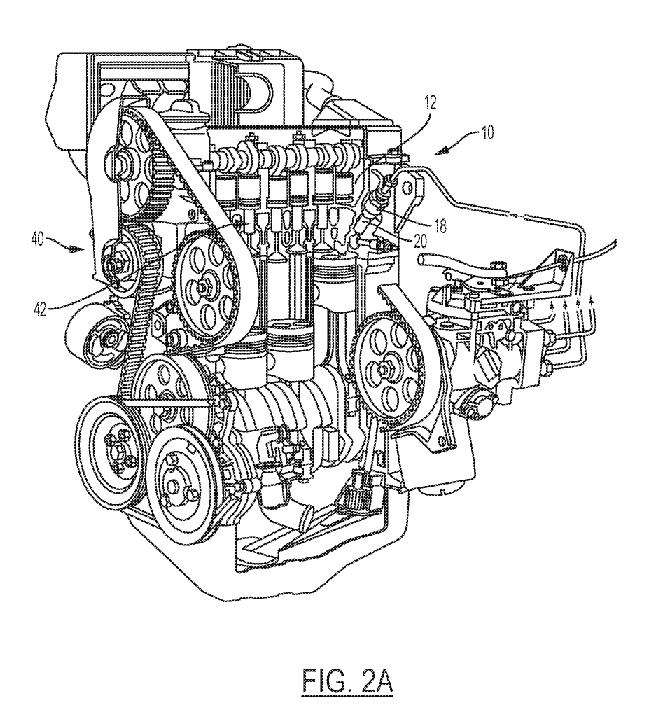

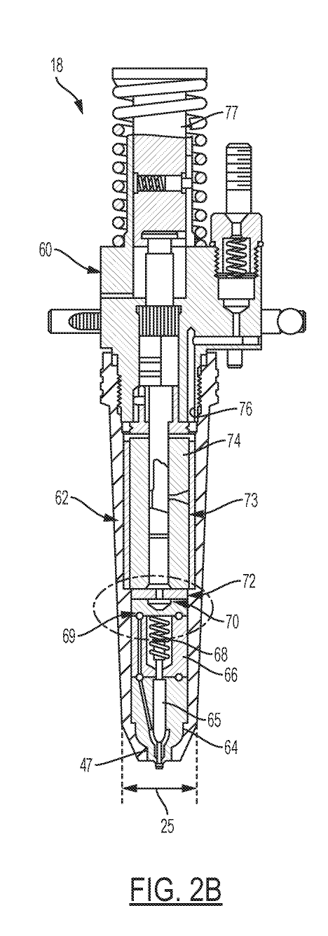

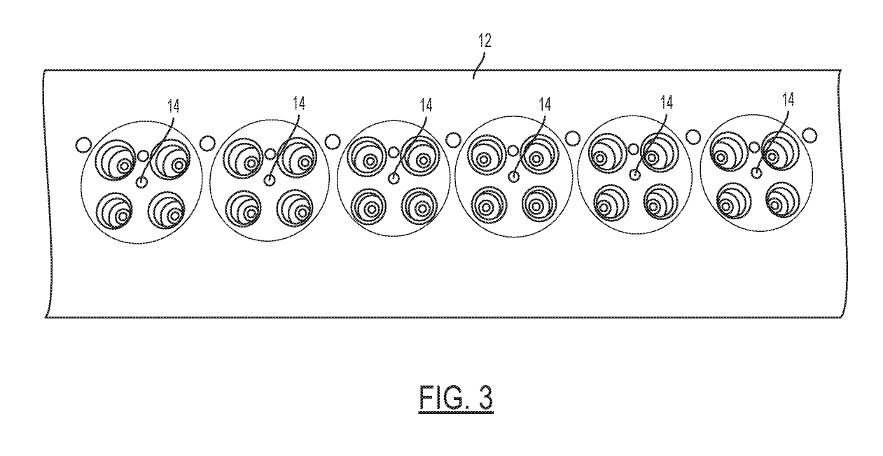

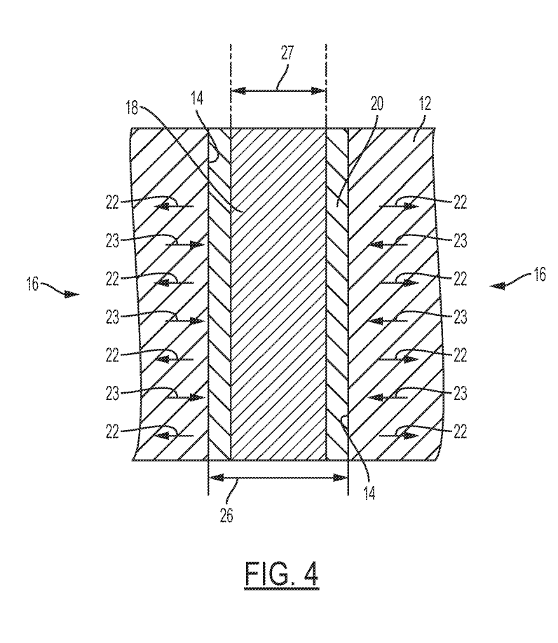

With reference to FIG. 1, a schematic cross-sectional view of the fuel injector assembly 10 of the present disclosure is shown. The fuel injector assembly 10 may include a fuel injector 18, a pre-loading insert 20, and an engine head 12. The fuel injector 18 is configured to dispense fuel 44 into a corresponding combustion chamber 46. The engine head 12 (also shown in FIGS. 2A and 3) defines a bore 14 having an inner diameter (shown as element 26 in FIG. 4). The bore 14 also includes a head region 16 proximate to the combustion chamber wherein the head region of the bore is configured to receive the pre-loading insert 20 which, in part, supports the fuel injector. As shown in FIG. 1, the injector nozzle 47 (FIG. 2B) extends through the pre-loading insert 20.

With reference to FIG. 2B, an example fuel injector 18 of the present disclosure may, but not necessarily, include an injector body 60 and a thread attached nut 62 within which are clamped a spray tip 64 carrying a needle valve 65, a spring cage 66 carrying a valve spring 68, a check valve cage 69 carrying a check valve 70, a spacer 72 and a bushing 73 receiving a reciprocal plunger 74. Passages 26 in the injector body 60 and bushing supply fuel to the bushing interior for pumping under high pressure by the plunger. A follower 77 may engage the plunger for actuating it such that the fuel injector 18 dispenses fuel into a combustion chamber 46. Alternatively, the plunger 74 may be electronically actuated instead of mechanically actuated by follower 77.

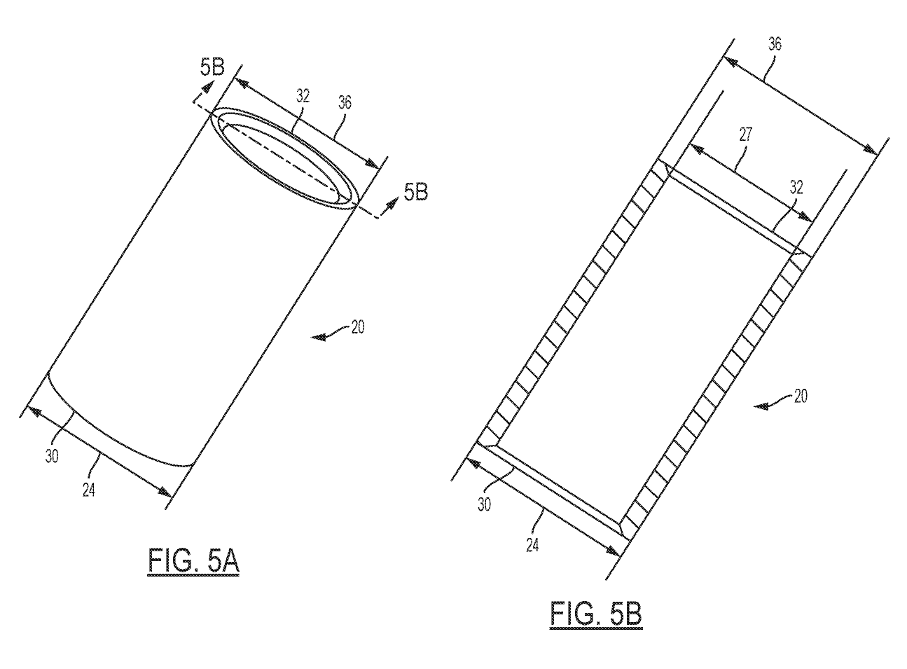

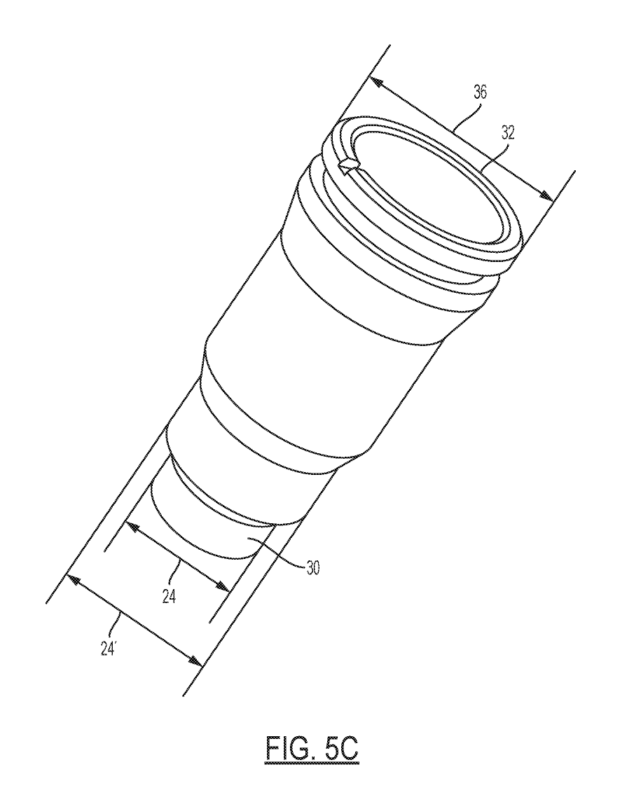

With reference again to FIGS. 1 and 5, the pre-loading insert 20 may be formed from stainless steel and includes an outer diameter 24, 24′ (FIGS. 5A-C) at the first end 30. It is understood that the outer diameter 24, 24′ is greater than the inner diameter 26 (FIG. 4) of the bore 14 at the head region 16 (see FIG. 3) by about 30 to 50 microns. As indicated, it is understood that the head region 16 (FIGS. 1 and 4) is the region which experience a much higher temperature gradient than the remainder of the bore and the head region is proximate to a corresponding combustion chamber 46 of the engine as shown in FIG. 1. The nozzle 47 (FIG. 2B) of the fuel injector may extend through the pre-loading insert 20 (FIG. 1).

As also shown in FIG. 4, it is understood that the pre-loading insert 20 may be configured to apply a tensile hoop stress 22 to the head region 16 of the bore 14 while also supporting the fuel injector 18 within the bore 14 given that the outer diameter 24 (FIGS. 5A-5B) of the pre-loading insert 20 is greater than an inner diameter 26 (FIG. 4) of the head region 16. However, upon insertion into the bore 14, the head region 16 of the bore 14 is configured to elastically deform in an outward radial direction. Therefore, as shown in FIG. 4, prior to engine operation and increased temperatures to due to combustion, the head region 16 of the bore 14 is subject to a tensile hoop stress 22 given that the outer diameter 24 (FIG. 5A-5B) of the pre-loading insert 20 is slightly greater than the inner diameter 26 of the bore 14. As previously indicated, the head region 16 of the bore is subjected to a much higher temperature gradient when the engine is in operation due to its proximity to the combustion chamber.

In one non-limiting example, the outer diameter 24 (FIGS. 5A-5B) of the pre-loading insert 20 may be greater than the inner diameter 26 (FIG. 4) of head region 16 (of the bore 14) by approximately 30 to 50 microns. The slight difference in width between the pre-loading insert 20 and the bore 14 at the head region enables the bore 14 to elastically deform in that area under ambient temperatures due to the tensile hoop stress 22 (FIG. 4) applied by the pre-loading insert 20. As the engine heats up to temperatures in excess of 300 degrees Celsius, the head region 16 of the bore 14 may either not experience thermal expansion at the increased temperatures or it may experience significantly reduced thermal expansion at the increased temperatures given that the pre-loaded tensile hoop stress 22 (FIG. 4) initially applied to the bore 14 by the pre-loading insert 20 reduces or offsets the compressive stress 23 (FIG. 4) at higher temperatures. Given that the bore 14 shall expand (under increasing temperatures) and contract (under decreasing temperatures) across a smaller range, the bore wall is less likely to undergo thermo-mechanical failure thus reducing the risk of cracks or other damage in the bore wall 14.

With further reference to FIGS. 5A, 5B, and 5C, it is further understood that the pre-loading insert 20 may further include a first end 30 having a first outer diameter 24 as well as a second end 32 having a second outer diameter 36. As shown, the pre-loading insert 20 is disposed within or substantially within the head region 16 of the bore 14. The pre-loading insert (like the head region of the bore) is generally disposed proximate to combustion chamber. The tip of the fuel injector nozzle may, but not necessarily, extend into the pre-loading insert as shown in FIG. 4. As shown in FIG. 2A, the second end 32 of the pre-loading insert 20 may also be configured to substantially provide vertical support to the injector within the bore 14 of the engine head 12 given that the pre-loading insert may be disposed between combustion chamber and the injector 18 while the injector nozzle 47 extends through the pre-loading insert 20. (FIG. 1) In order to withstand the high temperatures of the combustion reaction within each combustion chamber 46, the pre-loading insert 20 may, but not necessarily, be formed from a steel alloy. Also, in order to decrease overall vehicle weight, the engine head 12 may be formed from aluminum. This fuel injector assembly 10 of the present disclosure is particularly useful where the engine head 12 is affixed to a diesel engine 40 given the direct injection method used in diesel engines—such that fuel injectors 18 and bores 14 are subjected to repeated cycles between high temperatures and low temperatures.

Referring back to FIG. 2A, it is understood that the present disclosure may also provide a more robust vehicle engine 50 which includes an engine head 12, an engine cylinder bank 42 affixed to the engine head 12, a fuel injector 18 and a pre-loading insert 20 (see FIG. 1). The engine head 12 of the vehicle engine 50 may define a bore 14 wherein the bore 14 includes a head region 16 proximate to the engine cylinder bank 42 as shown in FIG. 1. The fuel injector 18 may be configured to dispense fuel 44 (FIG. 1) into the engine cylinder bank 42. The pre-loading insert 20 may be disposed within the head region 16 of the bore 14 as shown in FIG. 1. The head region 16 of the bore 14 may, but not necessarily, have an inner diameter which is less than the inner diameter of injector region 17 of the bore 14. The pre-loading insert 20 may be configured to apply a tensile hoop stress 22 to the head region 16 of the bore 14 such that the head region 16 of the bore 14 plastically deforms upon insertion of the pre-loading insert 20 into the bore 14. Moreover, the pre-loading insert 20 may also support and/or protect the fuel injector 18 within the bore 14 given that the pre-loading insert is disposed between the injector 18 and the combustion chamber while the injector nozzle 47 extends through the pre-loading insert 20. (FIG. 1)

With reference again to FIGS. 1, 5A, 5B, and 5C, the pre-loading insert 20 may be formed from stainless steel and includes an outer diameter 24 at the insert head region 16, which is greater than the inner diameter 26 (FIG. 4) of the bore 14 (see FIG. 3) by about 30 to 50 microns. It is understood that the pre-loading insert 20 and head region 16 of the bore 14 is the region experience a much higher temperature gradient compared to the remainder of the fuel injector assembly 10 and the injector region 17 of the bore. As shown, the outer diameter 25 (FIG. 2B) of the fuel injector 18 may, but not necessarily, be greater than or equal to the insert inner diameter 27 (see FIG. 1).

It is understood that the pre-loading insert 20 may be configured to apply a tensile hoop stress 22 to the head region 16 of the bore 14 while also supporting the fuel injector 18 within the bore 14 given that the pre-loading insert 20 is disposed between the injector 18 and the combustion chamber while the injector nozzle 47 extends through the pre-loading insert 20. (FIG. 1) However, upon insertion of the pre-loading insert 20 into the bore 14, the head region 16 of the bore 14 is configured to elastically deform in an outward radial direction. Therefore, prior to engine operation and increased temperatures to due to combustion, the head region 16 of the bore 14 is subject to a tensile hoop stress 22 (FIG. 4) given that the outer diameter 24 of the pre-loading insert 20 is slightly greater than the inner diameter 26 (FIG. 4) of the head region 16 of the bore 14. In one non-limiting example, the outer diameter 24 of the pre-loading insert 20 may be greater than the inner diameter 26 (FIG. 4) of the head region 16 of the bore 14 by approximately 30 to 50 microns. The slight difference in width between the pre-loading insert 20 and the bore 14 enables the bore 14 to elastically deform the head region 16 under ambient temperatures.

With further reference to FIGS. 5A, 5B, and 5C, it is further understood that the pre-loading insert 20 may further include a first end 30 having a first outer diameter 24 as well as a second end 32 having a second outer diameter 36. The first end 30 of the pre-loading insert 20 is disposed substantially within or within the head region 16 of the bore 14. Both the pre-loading insert and the head region of the bore 14 are generally disposed proximate to the fuel injector nozzle 47 (see FIG. 1), and therefore, experience a much higher temperature gradient than the injector region 17 of the bore 14. As shown in FIGS. 2A and 5B, the second end 32 of the pre-loading insert 20 may also be configured to substantially provide vertical support to the injector 18 within the bore 14 of the engine head 12. In order to withstand the high temperatures of the combustion reaction within each combustion chamber 46, the pre-loading insert 20 may, but not necessarily, be formed from a steel alloy. Also, in order to decrease overall vehicle weight, the engine head 12 may be formed from aluminum. This fuel injector 18 assembly is particularly useful where the engine head 12 is affixed to a diesel engine 40 given the direct injection method used in diesel engines 40 such that fuel injectors 18 and bores 14 are subjected to repeated cycles between high temperatures and cooling.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A fuel dispersion assembly for a vehicle comprising:
an engine head defining a bore, the bore having a head region;
a fuel injector; and
a pre-loading insert disposed within the bore wherein the bore supports the pre-loading insert via a tensile hoop stress distributed between the pre-loading insert and the bore at the head region of the bore.

2. The assembly as defined in claim 1 wherein the pre-loading insert includes an outer diameter which is greater than an inner diameter of the head region of the bore.

3. The assembly as defined in claim 2 wherein the outer diameter of the pre-loading insert is greater than the inner diameter of the head region of the bore by approximately 30 to 50 microns.

4. The assembly as defined in claim 2 wherein the head region of the bore is configured to elastically deform upon insertion of the pre-loading insert into the bore.

5. The assembly as defined in claim 4 wherein the pre-loading insert further includes a first end having a first outer diameter and a second end having a second outer diameter.

6. The assembly as defined in claim 5 wherein the second end of the pre-loading insert is configured to substantially provide vertical support to the injector within the engine head.

7. The assembly as defined in claim 6 wherein the pre-loading insert is formed from a steel alloy.

8. The assembly as defined in claim 7 wherein the engine head is formed from aluminum.

9. The assembly as defined in claim 8 wherein the engine head is affixed to a diesel engine.

10. A vehicle engine comprising:
an engine head defining a bore, the bore having a head region;
an engine cylinder bank affixed to the engine head;
a fuel injector configured to dispense fuel into the engine cylinder bank; and
a pre-loading insert disposed within the bore, the pre-loading insert being supported by the bore via a tensile hoop stress distributed between the head region of the bore and the pre-loading insert.

11. The vehicle engine as defined in claim 10 wherein the pre-loading insert includes an outer diameter which is greater than an inner diameter of the bore at the head region.

12. The vehicle engine as defined in claim 11 wherein the outer diameter of the pre-loading insert is greater than the inner diameter of the bore by approximately 30 to 50 microns.

13. The vehicle engine as defined in claim 11 wherein the head region of the bore is configured to elastically deform upon insertion of the pre-loading insert.

14. The vehicle engine as defined in claim 13 wherein the pre-loading insert further includes a first end having a first outer diameter and a second end having a second outer diameter.

15. The vehicle engine as defined in claim 14 wherein the second end of the pre-loading insert is configured to substantially provide vertical support to the fuel injector within the engine head.

16. The vehicle engine as defined in claim 16 wherein the pre-loading insert is formed from a steel alloy.

17. The vehicle engine as defined in claim 16 wherein the engine head is formed from aluminum.
